(19) United States
(12) Patent Application Publication
(10) Pub. No.: US 2012/0051718 A1
(43) Pub. Date: Mar. 1, 2012

(54) RECEIVER

(76) Inventors: Masayoshi MIURA, Chigasaki (JP); Sadao Tsuruga, Yokohama (JP); Takashi Kanemaru, Yokohama (JP); Satoshi Otsuka, Yokohama (JP)

(21) Appl. No.: 13/163,048

(22) Filed: Jun. 17, 2011

(30) Foreign Application Priority Data
Aug. 30, 2010 (JP) 2010-191636

(51) Int. Cl. H04N 13/00; H04N 9/80

(52) U.S. Cl. 386/248; 348/43; 348/E13.068; 386/E05.003

(57) ABSTRACT

A receiver includes a reception unit that receives a digital broadcast signal that includes content, wherein the content includes a video signal and identification information indicating that the video signal includes a 3D video signal; a conversion unit that converts a 3D video signal to a 2D video signal; a control unit that rewrites the identification information; and a recording unit that can record the content, which is included in the digital broadcast signal received by the reception unit, to a recording medium wherein the conversion unit converts a 3D video signal, included in the content, to a 2D video signal and, when the content is recorded to the recording medium, the control unit rewrites the identification information included in the content.

### INCORPORATION BY REFERENCE

The present application claims priority from Japanese application JP2010-191636 filed on Aug. 30, 2010, the content of which is hereby incorporated by reference into this application.

### BACKGROUND OF THE INVENTION

The technical field relates to a receiver and a reception method for receiving a broadcast and to a transmission/reception method.

JP-A-2003-9033 (Patent Document 1) describes that the problem is “to provide a digital broadcast receiver that actively notifies a user that a user-desired program will start on a certain channel” (see [0005] in Patent Document 1) and the solution is that “the digital broadcast receiver comprises means that retrieves program information included in the digital broadcast wave and, using the user-registered selection information, selects a program for which the user wants to receive notification; and the means that inserts into the currently-displayed screen a message notifying that the selected program, for which the user want to receive notification, is present,” (see [0006]) in Patent Document 1).

### SUMMARY OF THE INVENTION

However, Patent Document 1 does not disclose a technology for processing information on 3D content the user views. Therefore, the problem is that the disclosed technology can neither identify that the program the receiver is receiving or will receive is a 3D program nor perform proper management when the received content is recorded.

To solve the problem described above, the present invention employs the configuration described in Claims.

The present application includes several means for the problems described above. One example includes a reception unit that receives a digital broadcast signal that includes content, wherein the content includes a video signal and identification information indicating that the video signal includes a 3D video signal; a conversion unit that converts a 3D video signal to a 2D video signal; a control unit that rewrites the identification information; and a recording unit that can record the content, which is included in the digital broadcast signal received by the reception unit, to a recording medium wherein the conversion unit converts a 3D video signal, included in the content, to a 2D video signal and, when the content is recorded to the recording medium, the control unit rewrites the identification information included in the content.

When content is received and recorded, the means described above allows the user o manage the content appropriately, thus increasing the user's ease of use.

### BRIEF DESCRIPTION OF THE DRAWINGS

FIG. 1 is a block diagram showing an example or the system configuration.

FIG. 2 is a block diagram showing an example of the configuration of a transmitter 1.

FIG. 3 is a diagram showing a display screen used for 2D conversion recording.

FIG. 4 is a diagram showing a display screen used for 2D conversion recording.

FIG. 5A is a diagram showing the data structure of a 3D identifier.

FIG. 5B is a diagram showing the data structure of a 3D identifier.

FIG. 5C is a diagram showing the data structure of a 3D identifier.

FIG. 5D is a diagram showing the data structure of a 3D identifier.

FIG. 6 is a diagram showing the concept of the 2D conversion of SBS format content.

FIG. 7 is a diagram showing an example of the processing procedure for converting SBS format content to 2D.

FIG. 8 is a diagram showing an example of the recording processing procedure in this embodiment.

FIG. 9 is a diagram showing an example of the recording processing procedure in this embodiment.

FIG. 10 is a functional block diagram shoving the internal of a recording/reproduction unit.

FIG. 11 is a diagram showing an example of the recording processing procedure in this embodiment.

FIG. 12 is a diagram showing an example of the recording processing procedure in this embodiment.

FIG. 13 is a diagram showing the configuration of a receiver in this embodiment.

FIG. 14 is a diagram showing an example of the general configuration of the internal functional blocks of the CPU of the receiver in this embodiment.

FIG. 15 is a block diagram showing an example of the system configuration.

FIG. 16 is a block diagram showing an example of the system configuration.

FIGS. 17A and 17B are diagrams showing an example of the 3D reproduction/output/display processing of 3D content.

### DETAILED DESCRIPTION OF THE INVENTION

A preferred embodiment (examples) of the present invention will be described below. Note that the present invention is not limited to this embodiment. Although a receiver is mainly described in this embodiment and the present invention is advantageously applicable to a receiver, the present invention is applicable also to devices other than a receiver. The whole configuration of this embodiment need not be employed but the components may be optionally selected.

In the description of this embodiment below, 3D means three dimensions and 2D means two dimensions. For example, 3D video means that video, with parallax difference between the two eyes, is presented to make an observer feel as if an object was stereoscopically in the same space as that of the observer. Also, 3D content refers to content that includes video signals that can be displayed as 3D video through the processing of a display device.

The 3D video display methods include the anaglyph method, polarized display method, frame sequential method, parallax barrier method, lenticular lens method, micro-lens array method, and light ray reproduction method.

The anaglyph method is a method in which video, shot from different angles on the left and right sides, is reproduced by superimposing the red light and the cyan light and the reproduced video is viewed with glasses (hereinafter called “anaglyph glasses”) that have red and cyan color filters on the left and right.

The polarized display method is a method in which the orthogonal linearly-polarized lights are used for the left and right, videos to produce a projected image and the projected image is separated by the glasses (called “polarized glasses”) that have polarized filters.

The frame sequential method is a method in which video, shot from different angles on the left and right sides, is alternately reproduced and the reproduced video is viewed by the glasses having a shutter that alternately blocks the left and right visual fields (The glasses do not necessarily have to take the form of glasses but refer to a device capable of controlling the light transmission level of the elements in the lens through the electrical characteristics. Hereinafter, the glasses are called also “shutter glasses”).

The parallax barrier method is a method in which vertical stripe barriers, called “parallax barriers”, are overlapped on the display to allow the right eye to see the right-eye video and the left eye to see the left-eye video. In this method, the user need not wear special glasses. The parallax barrier method is classified further into two methods: the two-view method in which the viewing area is relatively small and the multi-view method in which the viewing area is relatively large.

The lenticular lens method is a method in which lenticular lenses are overlapped on the display to allow the right eye to see the right-eye video and the left eye to see the left-eye video In this method, the user need not wear special glasses. The lenticular lens method is classified further into two methods: the two-view method in which the viewing area is relatively small and the multi-view method in which the viewing area is relatively large horizontally.

The micro-lens array method is a method in which micro-lens arrays are overlapped on the display to allow the right eye to see the right-eye video and the left eye to see the left-eye video. In this method, the user need not wear special glasses. The micro-lens array method is a multi-view method in which the viewing area is relatively large vertically and horizontally.

The light ray reproduction method is a method in which the wave front of a light ray is reproduced to provide an observer with a parallax image. In this method, the user need not wear special glasses. The viewing area is relatively large.

The 3D video display methods are exemplary only, and a method other than those given above may also be used. The instruments or devices required to view 3D images, such as anaglyph glasses, polarized glasses, and shutter glasses, are called generically 3D glasses or 3D viewing assist devices.

### <System>

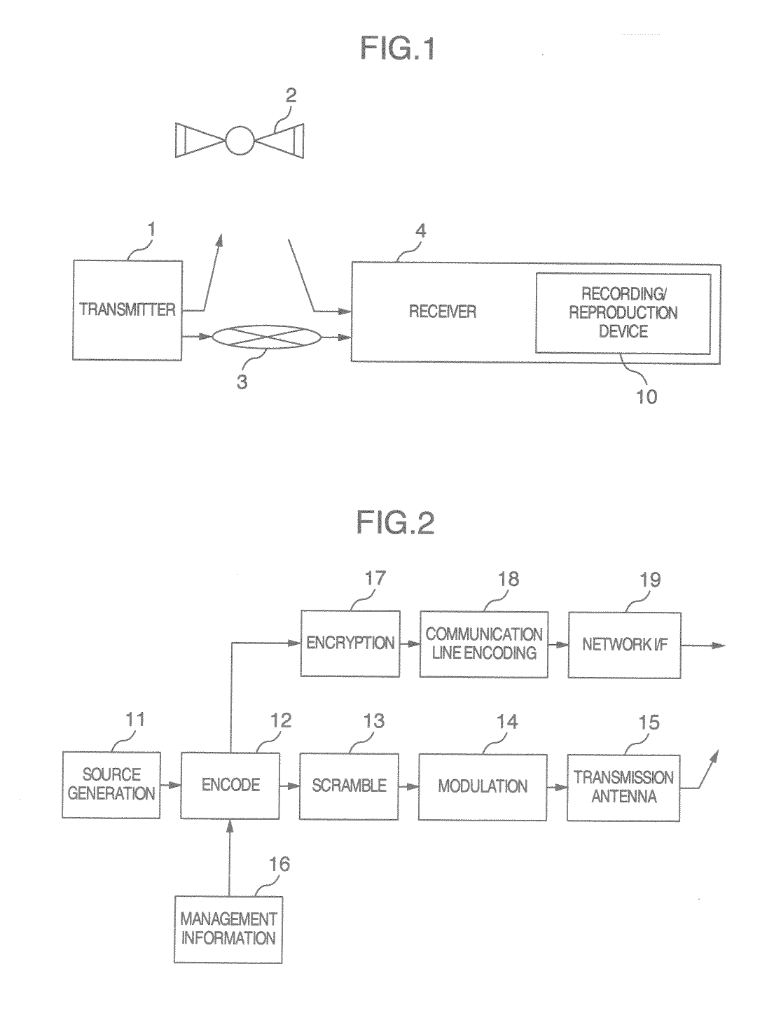

FIG. 1 is a block diagram showing an example of the configuration of a system in this embodiment. The figure shows that information is transmitted and received via broadcast for recording and reproduction. This information transmission and reception is not limited to a broadcast but may be applied also to VOD (Video On Demand) delivered via communication. This is generically called delivery.

The numeral 1 indicates a transmitter installed in an information providing station such as a broadcast station, the numeral 2 indicates an intermediary device installed in an intermediary station or a broadcast satellite, the numeral 3 indicates a public switched network, such as the Internet, via which homes and the broadcast station are connected, the numeral 4 indicates a receiver installed in a user's home, and the numeral 10 indicates a recording/reproduction device (reception/recording/reproduction unit) included in the receiver 4. The recording/reproduction device 10 is capable of recording/reproducing broadcast information or reproducing content from a removable external medium.

The transmitter 1 transmits a modulated signal wave via the intermediary device 2. In addition to the transmission via a satellite such as that shown in the figure, the transmission via a cable, the transmission via a telephone line, the transmission via a terrestrial broadcast, or the transmission via a network, such as the Internet where information is transmitted via the public switched network 3, may also be used. As will be described later, the signal wave received by the receiver 4 is demodulated to an information signal and, as necessary, recorded on a recording medium. When transmitted via the public switched network 3, the signal wave is converted to a format such as the data format (IP packet) conforming to the protocol (for example, TCP/IP) suitable for the public switched network 3. After that, when the data is received, the receiver 4 decodes the received data to an information signal, changes the decoded signal for recording as necessary, and records it on a recording medium. When a display is included in the receiver 4, the user can enjoy the video and sound of the information signal on the display; when a display is not included, the user can enjoy the video and sound of the information signal by connecting the receiver 4 to a display not shown.

### <Transmitter>

FIG. 2 is a block diagram showing an example of the configuration of the transmitter 1 included in the system shown in FIG. 1.

The numeral 11 indicates a source generation unit, the numeral 12 indicates an encode unit that compresses information using the MPEG2 or H.264 method and adds program information and so on to the compressed information, the numeral 13 indicates a scramble unit. the numeral 14 indicates a modulation unit, the numeral 15 indicates a transmission antenna, and the numeral 16 indicates a management information assignment unit. The information, such as video and sound generated by the source generation unit 11 composed of a camera and a recording/reproduction device, is compressed by the encode unit 12 so that the data amount becomes small enough to be transmitted over a smaller bandwidth. The scramble unit 13 encrypts the transmission information as necessary to allow the limited viewers to view the information. The information is modulated by the modulation unit 14 to the signals suitable for transmission by OFDM, TC8PSK, QPSK, and multi-level QAM and after that, transmitted to the intermediary device 2 via the transmission antenna 15 as a radio wave. At this time, the management information assignment unit 16 assigns the following information to the transmission information: the program identification information such as the attributes of the content created by the source generation unit 11 (for example, video or sound encoding information, sound encoding information, program configuration, information indicating whether the information is 3D video) and the program array information created by the broadcast station (for example, configuration of the current program and the next program, service form, configuration information on the programs for one week). In the description below, the program identification information and the program array information are called collectively program information.

In many cases, multiple pieces of information are multiplexed in one radio wave using a method such as time division or spread spectrum. Although not shown in FIG. 2 for brevity, multiple sets of the source generation unit 11 and the encode unit 12 are provided in this case with a multiplexing unit between the encode unit 12 and the scramble unit 13 for multiplexing the multiple pieces of information.

Similarly, when transmitted via the public switched network 3, the signal created by the encode unit 12 is encrypted by an encryption unit 17 as necessary to allow the limited viewers to view the information. After encoded by a communication line encoding unit 18 as a signal suitable for transmission over the public switched network 3, the signal is transmitted from a network I/F(Interface) unit 19 to the public switched network 3.

### <3D Transmission Method>

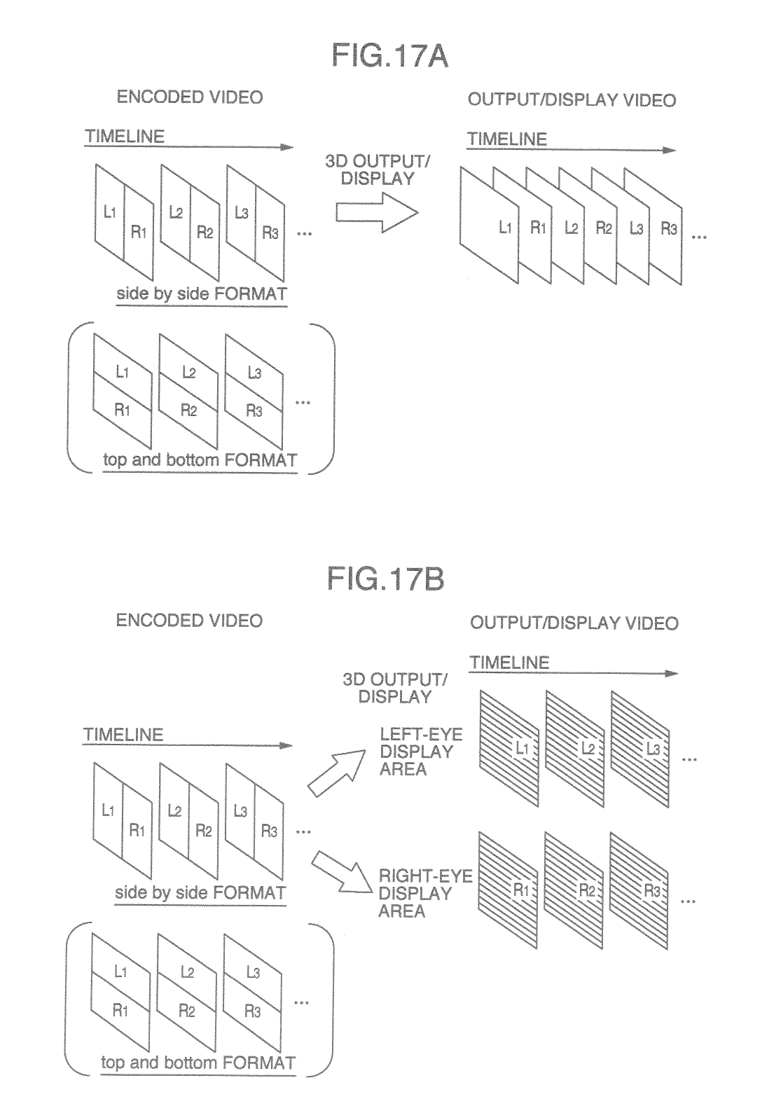

The transmission method of a 3D program transmitted from the transmitter 1 is classified roughly into two methods, in one method, the left-eye video and the right-eye video are stored in one image using the existing 2D program broadcasting method. This method uses the existing MPEG2 (Moving Picture Experts Group 2) or H.264 AVC as the video compression method. This method, which is compatible with the existing broadcast, uses the existing relay infrastructure and allows the existing receivers (STB and the like) to receive a broadcast, but transmits a 3D video at half of the maximum resolution of the existing broadcast (vertical or horizontal). FIG. 17A shows some examples of this method. The “Side-by-Side” format (hereinafter denoted as SBS) divides one image vertically into two wherein the screen size is that the horizontal width of each of the left-eye video (L) and the right-eye video (R) is about half of that of a 2D program and the vertical width is equal to that of a 2D program. The “Top-and-Bottom” format (hereinafter denoted as TAB) divides one image horizontally into two wherein the screen size is that the horizontal width of each of the left-eye video (L) and the right-eye video (R) is equal to that of a 2D program and the vertical width is about half of that of a 2D program. Other formats include the “Field alternative” format that stores an image using interlaces, the “Line alternative” format that stores the left-eve video and the right-eye video alternately on the scan lines, and the “Left+Depth” format that stores the two-dimensional (one-side) video and the depth (distance to the object) information for each pixel of the video. Because those formats divide one image into multiple images and store the images of multiple views, the MPEG2 or H.264 AVC(excluding MVC) encoding method, which is originally not a multi-view video encoding method, may be used directly as the encoding method and so the merit is that a 3D program may be broadcast using the existing 2D program broadcast method. For example, when a 3D program is broadcast in the SBS format using the screen size in which a 2D program may be transmitted with the maximum horizontal length of 1920 dots and the vertical length of 1080 lines, one image is divided vertically into two, left-eye video (L) and right-eye video (R), which are then transmitted each with the screen size of the horizontal length of 960 dots and the vertical length of 1080 lines, Similarly, when a 3D program is broadcast in the TAB format in this case, one image is divided horizontally into two, left-eye video (L) and right-eye video (R), which are then transmitted, each with the screen size of the horizontal length of 1920 dots and the vertical length of 540 lines.

In another method, the left-eye video and the right-eye video are transmitted each as a separate stream (ES). In this embodiment, this method is called “3D, 2-view ES transmission”. An example of this method is an H.264 MVC-based transmission method that is a multi-view video coding method. This transmission method has the advantages of high-resolution 3D video transmission. The use of this method achieves the effect that a high-resolution 3D video can be transmitted. The multi-view video coding method, a coding method standardized for encoding multi-view video, encodes multi-view videos without dividing one image, one separate image for each view.

When transmitted in this method, a 3D video may be transmitted, for example, with the left-eye-view encoded-image as the main view image and with the right-eye-view encoded-image as the other-view image. Doing so allows the main view image to maintain compatibility with the existing broadcast method of a 2D program, For example, when H.264 MVC is used as the multi-view video coding method, the main view image can maintain compatibility with a 2D image of H.264 AVC for the H.264 MVC base sub-stream and so the main-view image may be displayed as a 2D image.

In addition, the embodiment of the present invention includes the following method as another example of the “3D, 2-view; ES transmission method”.

As another example of the “3D, 2-view. ES transmission method”, there is a method in which the left-eye encoded image is encoded by MPEG2 as the main view image, the right-eye encoded image is encoded by H.264 AVC as the other view image, and the encoded images are transmitted, each as a separate stream. This method makes the main view image compatible with MPEG2 and allows it to be displayed as a 2D image, thus ensuring compatibility with the existing 2D-program broadcast method in which MPEG2-encoded images are widely used.

As another example of the “3D, 2-view ES transmission method”, there is a method in which the left-eye encoded image is encoded by MPEG2 as the main view image, the right-eye encoded image is encoded by MPEG2 as the other view image, and the encoded images are transmitted, each as a separate stream. This method also makes the main view image compatible with MPEG2 and allows it to be displayed as a 2D image, thus ensuring compatibility with the existing 2D program broadcast method in which MPEG2-encoded images are widely used.

As another example of the “3D, 2-view ES transmission method”, it is also possible to encode the left-eye encoded image by H.264 AVC or H.264 MVC as the main view image and to encode the right-eye encoded image by MPEG2 as the other view image.

In addition to the “3D, 2-view ES transmission method”, 3D transmission is also possible by generating a stream, in which the left-eye video and the right-eye frame are alternately stored, even in the encoding method such as MPEG2 or H.264 AVC (excluding MVC) that is originally not defined as a multi-view video encoding method.

### <Program Information>

The program identification information and the program array information are called the program information.

The program identification information, also called PSI (Program Specific Information), is information required to select a desired program. The program identification information is composed of the following four tables: PAT (Program Association Table) that specifies the packet identifier of a TS packet for transmitting a PMT (Program Map Table) related to a broadcast program, PMT that specifies the packet identifier of a TS packet for transmitting the encoded signal configuring a broadcast program and the packet identifier of a TS packet for transmitting the common information of pay-broadcast related information, NIT (Network Information Table) that transmits information for relating the transmission line information, such as the modulation frequency, to a broadcast program, and CAT (Conditional Access Table) that specifies the packet identifier of a TS packet for transmitting the individual information of pay-broadcast related information. The program identification information is defined by the MPEG2 system specification. For example, the program identification information includes the video encoding information, sound encoding information, and program configuration. In the present invention, the program identification information also includes the information indicating whether or not the program is 3D video The PSI is added by the management information assignment unit 16.

The program array information, also called SI (Service information), includes various types of information defined for ease of program selection as well as the PSI information defined by the MPEG-2 system specifications. The program array information is, for example, EIT (Event Information Table) in which program information, such as program names, broadcast date/time, and program contents, is described and the SDT (Service Description Table) in which information on sub-channels (services), such as the sub-channel names and broadcast operator names, are described.

For example, the program array information includes information on the configuration of the program that is being broadcast or will be broadcast next, service forms, and configuration information on the programs for one week. This information is added by the management information assignment unit 16.

The PMT table and the EIT table are used properly as follows. For example, with the PMT that stores only the information on the program being broadcast, the information on a program that will be broadcast in future cannot be confirmed. However, the PMT is reliable in that the time to the completion of reception is short because the periodic interval of transmission from the transmitter is short and in that the table is not updated because the table stores the information on the currently-broadcast program. On the other hand, with the EIT [schedule basic/schedule extended], the information not only on the currently broadcast program but on the programs for the next seven days may be obtained. However, the EIT has a demerit in that the time to the completion of reception is long because the periodic interval of transmission from the transmitter is longer than that of the PMT and therefore a larger storage area is required and in that the reliability is low because the table that stores future events may be updated.

### <Hardware Configuration of Receiver>

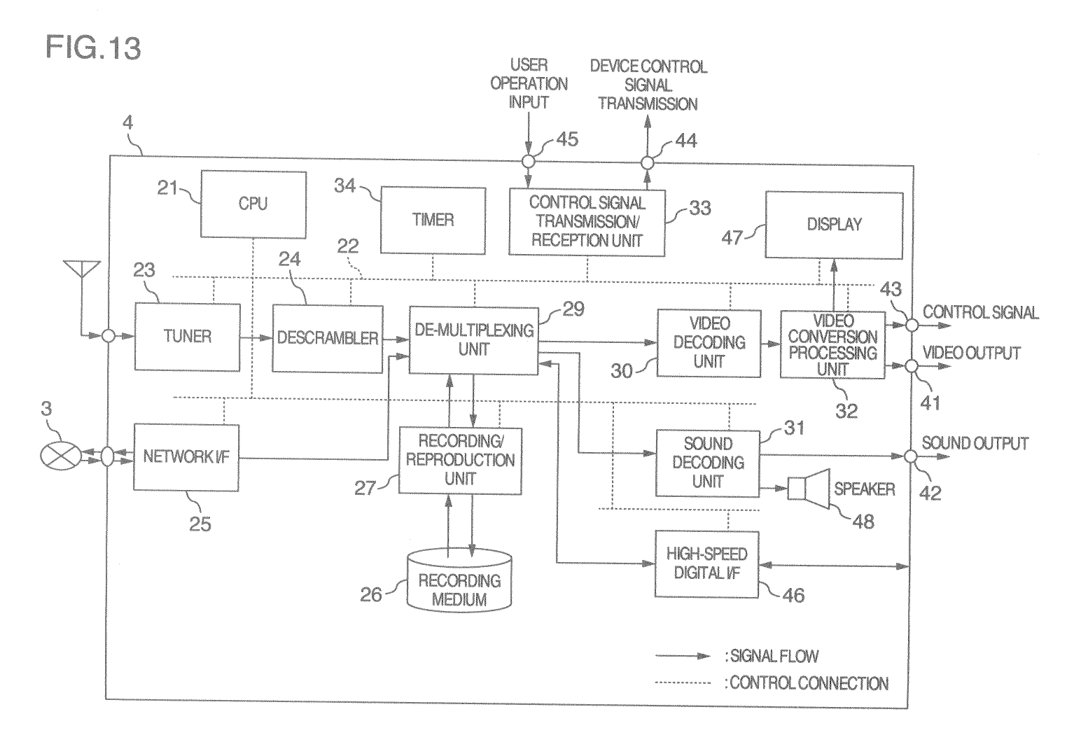

FIG. 13 is a hardware configuration diagram showing an example of the configuration of the receiver 4 included in the system shown in FIG. 1. The numeral 21 indicates a CPU (Central Processing Unit) that controls the entire receiver. The numeral 22 indicates a general-purpose bus via which the CPU 21 and the components in the receiver are controlled and the information is transmitted.

The numeral 23 indicates a tuner hat receives a broadcast signal from the transmitter 1 via a broadcast transmission network such as a radio (satellite, ground) or cable network, selects a particular frequency, performs demodulation and error correction processing, and outputs a multiplexed packet such as an MPEG2-Transport Stream (hereinafter also called “TS”).

The numeral 24 indicates a descrambler that decodes the information scrambled by the scramble unit 13. The numeral 25 indicates a network I/F (Interface) that transmits and receives information to and from the network and that transmits and receives various types of information and MPEG2-TSs between the Internet and the receiver.

The numeral 26 indicates a recording medium such as an HDD (Hard Disk Drive) or a flash memory that is included in the receiver 4 or an HDD, a disc-like recording medium, and a flash memory that is removal. The numeral 27 indicates a recording/reproduction unit that controls the recording medium 26 and controls the recording/reproduction of a signal to and from the recording medium 26.

The numeral 29 indicates a de-multiplexing unit that de-multiplexes a signal, multiplexed in the MPEG-2-TS format, into signals such as a video ES (Elementary Stream), a sound ES, or program information. An ES refers to image/sound data that is compressed and encoded.

The numeral 30 indicates a video decoding unit that decodes a video ES to a video signal. The numeral 31 indicates a sound decoding unit that decodes a sound ES to a sound signal and outputs the decoded sound signal to a speaker 48 or outputs the decoded sound signal from a sound output 42.

The numeral 32 indicates a video conversion processing unit. The video conversion processing unit 32 performs processing for converting the video signal, decoded by the video decoding unit 30, to a predetermined format via the later-described conversion processing, in which a 3D or 2D video signal is converted, according to an instruction from the CPU and as well as processing for superimposing the display such as an OSD (On Screen Display), created by the CPU 21, on the video signal. In addition, the video conversion processing unit 32 outputs the processed video signal to a display 47 or a video signal output unit 41, and outputs the synchronization signal and the control signal (used for device control), corresponding to the format of the processed video signal, from the video signal output unit 41 and a control signal output unit 43.

The numeral 33 indicates a control signal transmission/reception unit that receives an operation input (for example, a key code from the remote controller that issues an IR (Infrared Radiation) signal) from a user operation input unit 45, and transmits a device control signal (for example IR), generated by the CPU 21 or the video conversion processing unit 32 for output to an external device, from a device control signal transmission unit 44.

The numeral 34 indicates a timer that has an internal counter and keeps the current time. The numeral 46 indicates a high-speed digital I/F such as a serial interface or an IP interface. The high-speed digital I/F 46 performs necessary processing, such as encryption, for a TS reconfigured by the de-multiplexing unit and outputs the processed TS to an external device and, in addition, receives a TS from an external device, decodes the received TS, and supplies the decoded TS to the de-multiplexing unit 29.

The numeral 47 indicates the display that displays a 3D video or a 2D video that was decoded by the video decoding unit 30 and converted by the video conversion processing unit 32. The numeral 48 indicates the speaker that outputs sound based on the sound signal decoded by the sound decoding unit.

When a 3D video is displayed on the display, the synchronization signal and the control signal, if required, may be output either from the control signal output unit 43 and the device control signal transmission terminal 44 or from a signal output unit that is provided separately.

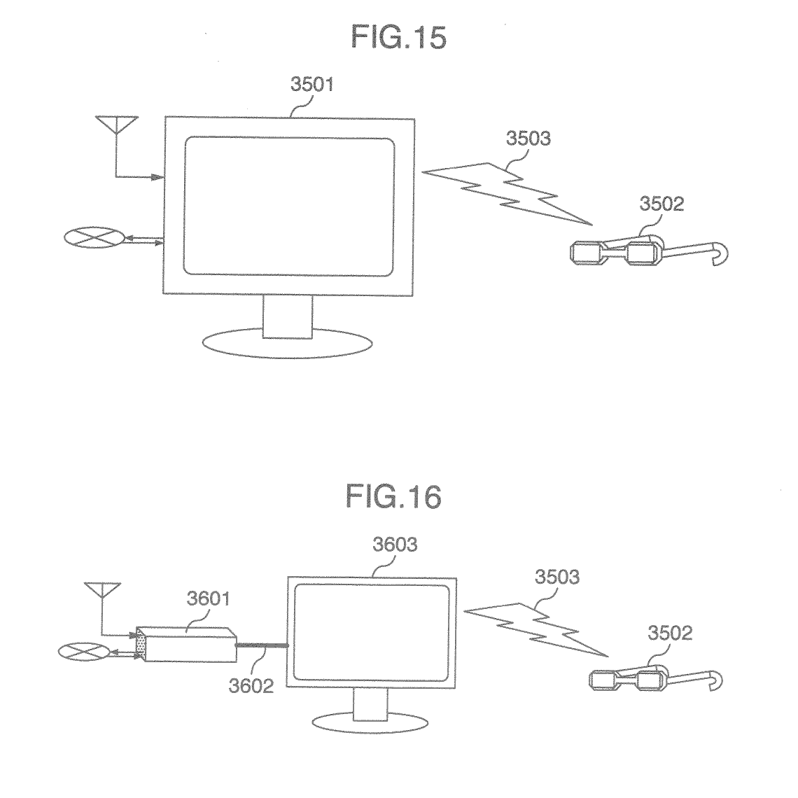

FIG. 15 and FIG. 16 show an example of the configuration of a system that includes a receiver, a viewing device, and a 3D viewing assist device (for example, 3D glasses). FIG. 15 shows an example of the system configuration in which the receiver and the viewing device are integrated, and FIG. 16 shows an example of the system configuration in which the receiver and the viewing devices are separately provided.

In FIG. 15, the numeral 3501 indicates a display device that includes the configuration of the receiver 4 and, in addition, can display a 3D video and output the sound. The numeral 3503 indicates a control signal (for example, IR signal) that is output from the display device 3501 for controlling the 3D viewing assist device. The numeral 3502 indicates a 3D viewing assist device.

In the example in FIG. 15, the video signal is displayed on the video display included in the display device 3501, and the sound signal is output from the speaker included in the display device 3501. Similarly, the display device 3501 has the output terminals from which the control signals are output. The control signals are those that are output from the output unit of the device control signal 44 or the output unit of the control signal 43 for controlling the 3D viewing assist device.

In the above description, an example is assumed in which the display device 3501 and the 3D viewing assist device 3502 shown in FIG. 15 are used to display video in the frame sequential method. When the display device 3501 and the 3D viewing assist device 3502 shown in FIG. 15 use the polarized display method, the 3D viewing assist device 3502 is polarized glasses and, in this case, a control signal 3503, which is output from the display device 3501 to the 3D viewing assist device 3502 in the frame sequential method, need not be output.

In FIG. 16, the numeral 3601 indicates a video/sound output device that includes the configuration of the receiver 4, the numeral 3602 indicates a transmission line (for example, HDMI cable) via which the video/sound/control signal is transmitted, and the numeral 3603 indicates a display that outputs and displays the video signal and the sound signal received from an external device.

In this case, the video signal output from the video output 41 of the video/sound output device 3601 (receiver 4), the sound signal output from the sound output 42, and the control signal output from the control signal output unit 43 are converted to transmission signals of the form conforming to the format defined for the transmission line 3602 (for example, the format defined by the MI specification) and, via the transmission line 3602, input to the display 3603.

The display 3603 receives the transmission signals, decodes the received transmission signals to the original video signal, sound signal, and control signal, outputs the video and the sound and, at the same time, outputs the 3D viewing assist device control signal 3503 to the 3D viewing assist device 3502.

In the above description, an example is assumed in which the display device 3603 and the 3D viewing assist device 3502 shown in FIG. 16 are used to display video in the frame sequential method, When the display device 3603 and the 3D viewing assist device 3502 shown in FIG. 16 use the polarized display method, the 3D viewing assist device 3502 is polarized glasses and, in this case, the control signal 3503, which is output from the display device 3603 to the 3D viewing assist device 3502 in the frame sequential method, need not be output.

A part of the components 21-46 shown in FIG. 13 may be configured by one or more LSIs. A part of the function of the components 21-46 shown in FIG. 13 may also be configured by software.

### <Functional Block Diagram of Receiver>

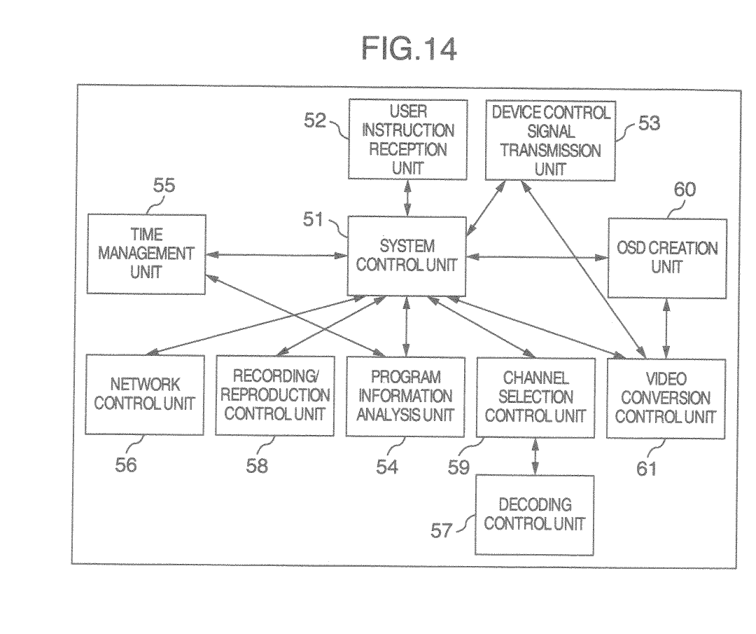

FIG. 14 is a diagram showing an example of the functional block configuration of the processing performed in the CPU 21. The functional blocks are software modules executed by the CPU 21, and some means (for example, message passing, function call, event transmission) are used to transfer information and data, as well as control instructions, among the modules.

Each module transmits and receives information to and from the hardware in the receiver 4 via the general-purpose bus 22. Although the relation lines (arrows) are used in the figure mainly to indicate the lines related to the description below, there is also processing that requires communication means and communication among other modules. For example, a channel selection control unit 59 acquires the program information, required for channel selection, from a program information analysis unit 54 as necessary.

Next, the following describes the function of each functional block. A system control unit manages the module status and the user instruction status and issues an instruction to each module. A user instruction reception unit 52 receives and interprets the input signal of a user operation received by the control signal transmission/reception unit 3 and transmits the user instruction to the system control unit 51.

A device control signal transmission unit 53 instructs the control signal transmission/reception unit 33 to transmit a device control signal according to an instruction form the system control unit 51 or some other module.

The program information analysis unit 54 acquires program information from the de-multiplexing unit 29, analyzes the contents, and supplies the necessary information to the modules. A time management unit 55 acquires the time correction information (TOT: Time offset table), included in a TS, from the program information analysis unit 54, manages the current time and, at the same time, uses the counter of the timer 34 to transmit an alarm (notifies that the specified time has arrived) or a one-shot timer notification (notifies that a predetermined time has elapsed) according to a request from each module.

A network control unit 56 controls the network I/F 25 and acquires various types of information and TSs from a particular URL (Unique Resource Locator) or a particular IP (Internet Protocol) address. A decoding control unit 57 controls the video decoding unit 30 and the sound decoding unit 31 to start or stop decoding or to acquire the information included in a stream.

A recording/reproduction control unit 58 controls the recording/reproduction unit 27 and reads the signal from a particular position in a particular content on the recording medium 26 in an arbitrary read format (playback, fast-forwarding, rewind, pause). The recording/reproduction control unit 58 also controls the recording of the signal, received by the recording/reproduction unit 27, onto the recording medium 26.

The channel selection control unit 59 controls the tuner 23, descrambler 24, de-multiplexing unit 29, and decoding control unit 57 to receive a broadcast and to record the broadcast signal. Alternatively, the channel selection control unit 59 controls a sequence of operations from the reproduction of information from a recording medium to the output of the video signal and the sound signal. The detailed broadcast reception operation and the broadcast signal recording operation and the detailed reproduction operation from a recording medium will be described later.

An OSD creation unit 60 creates OSD data, which includes a specific message, and instructs a video conversion control unit 61 to output the created OSD data with the OSD data superimposed on the video signal. In this case, the OSD creation unit 60 creates OSD data with a parallax difference, for example, left-eye and right-eye OSD data, and displays a message in 3D by requesting the video conversion control unit 61 to display 3D data based on the left-eye and right-eye OSD data.

The video conversion control unit 61 controls the video conversion processing unit 32 to convert the video signal, which is transmitted from the video decoding unit 30 to the video conversion processing unit 32, to 3D or 2D video according to an instruction from the system control unit 51, superimposes the converted video and the OSD received from the OSD creation unit 60, processes the video as necessary (scaling, PinP, 3D display, etc.), and displays the video on the display 47 or output the video to an external device. The details of how the video conversion processing unit 32 converts a 3D video or a 2D video to a predetermined format will be described later. The functional blocks perform the functions described above

### <Broadcast Reception>

The following describes the control procedure and the signal flow when a broadcast is received. First, the system control unit 51, which receives from the user instruction reception unit 52 a user instruction (for example, CH button on the remote control is pressed) indicating that the user is going to receive a broadcast from a particular channel (CH), instructs the channel selection control unit 59 to select a station corresponding to the user-specified CH (hereinafter called CH).

The channel selection control unit 59 that has received the instruction instructs the tuner 23 to perform the reception control of the specified CH (channel selection for specified frequency band, broadcast signal demodulation processing, error correction processing) and causes the tuner 23 to output a TS to the descrambler 24.

Next, the channel selection control unit 59 instructs the descrambler 24 to de-scramble the TS and output the de-scrambled TS to the de-multiplexing unit 29. The channel selection control unit 59 instructs the de-multiplexing unit 29 to de-multiplex the received TS, to output the de-multiplexed video ES to the video decoding unit 30, and to output the de-multiplexed sound ES to the sound decoding unit 31.

The channel selection control unit 59 issues a decoding instruction to the decoding control unit 57 to decode the video ES and the sound ES received by the video decoding unit 30 and the sound decoding unit 31 respectively. The decoding control unit 57 that has received the decoding instruction controls the video decoding unit 30 to output the decoded video signal to the video conversion processing unit 32 and controls the sound decoding unit 31 to output the decoded sound signal to the speaker 48 or the sound output 42 In this way, the output of the video and the sound of the user-specified CH is controlled.

To display a CH banner (OSD displaying the CH number, program name, program information) at station selection time, the system control unit 51 instructs the OSD creation unit 60 to create and output the CH banner. The OSD creation unit 60 that has received the instruction transmits the created CH banner data to the video conversion control unit 61 and, upon receiving the data, the video conversion control unit 61 controls the operation so that the video signal is output with CH banner superimposed. In this way, a message is displayed at channel selection time.

### <Recording of Broadcast Signal>

Next, the following describes the broadcast signal recording control and the signal flow When recording the signal of a particular CH, the system control unit 51 instructs the channel selection control unit 59 to select the particular CH and to output the signal to the recording/reproduction unit 27.

The channel selection control unit 59 that has received the instruction instructs the tuner 23 to perform the reception control of the specified CH as in the broadcast reception processing described above, controls the descrambler 24 to descramble the MPEG2-TS received from the tuner 23, and controls the de-multiplexing unit 29 to output the input, received from the descrambler 24, to the recording/reproduction unit 27.

The system control unit 51 instructs the recording/reproduction control unit 58 to record a TS that is input to the recording/reproduction unit 27. The recording/reproduction control unit 58 that has received the instruction performs necessary processing, such as encryption, for the signal (TS) that is input to the recording/reproduction unit 27, creates additional information (content information such as program information on recorded CH, bit rate, etc.) necessary at recording/reproduction time, records information into the management data (recorded content ID, recording position on recording medium 26, recording format, encryption information, etc.) and after that, writes the MPEG2-TS, additional information, and management data on the recording medium 26. In this way, the broadcast signal is recorded.

<Reproduction from Recording Medium>

Next, the following describes the reproduction processing from a recording medium. When reproducing a particular program, the system control unit 51 instructs the recording/reproduction control unit 58 to reproduce the particular program. The instruction issued in this case includes the content ID and the reproduction start position (for example, start of the program. 10 minutes from the start, continuation of the previous reproduction, 100M-bytes from the start).

The recording/reproduction control unit 58 that has received the instruction controls the recording/reproduction unit 27 to read the signal (TS) from the recording medium 26 using the additional information and the management data, to perform necessary processing such as decryption and, after that, to output the TS to the de-multiplexing unit 29.

The system control unit 51 instructs the channel selection control unit 59 to output the video and sound of the reproduction signal. The channel selection control unit 59 that has received the instruction performs control to output the input, received from the recording/reproduction unit 27, to the de-multiplexing unit 29 and instructs the de-multiplexing unit 29 to de-multiplex the received TS, to output the de-multiplexed video ES to the video decoding unit 30, and to output the de-multiplexed sound ES to the sound decoding unit 31.

The channel selection control unit 59 instructs the decoding control unit 57 to decode the video ES and the sound ES that are input to the video decoding unit 30 and the sound decoding unit 31. The decoding control unit 57 that has received the decoding instruction controls the video decoding unit 30 to output the decoded video signal to the video conversion processing unit 32 and controls the sound decoding unit 31 to output the decoded sound signal to the speaker 48 or the sound output 42. In this way, the signal is reproduced from the recording medium.

### <3D Video Display Method>

The 3D video display method that can be used in this embodiment includes several methods in which the left-eye video and the right-eye video are created that cause a parallax difference between the left-eye and the right-eye to make the human feel as if there was a 3D object.

One method is the frame sequential method. In this method, the left and right glasses of the glasses the user wear are alternately blocked by the liquid crystal shutters and, in synchronization with that, the left-eye and right-eye videos are displayed to generate a parallax difference in the images shown to the left and right eyes.

In this case, the receiver 4 outputs the synchronization signal and the control signal from the control signal output unit 43 and the device control signal transmission terminal 44 to the shutter glasses the user wears. In addition, the receiver 4 outputs the video signal from the video signal output unit 41 to an external 3D video display device to alternately display the left-eye video and the right-eye video.

Alternatively, the video is displayed in 3D similarly on the display 47 of the receiver 4. This configuration allows the user, who wears the shutter glasses, to view a 3D video on the 3D video display device or on the display 47 of the receiver 4.

Another method is the polarization display method. In this method, the films of orthogonal linearly polarized lights are pasted or a linearly polarized coating is provided, or the films of circularly polarized lights with the reversely rotating polarization axis are pasted or a circularly polarized coating is provided, on the left and right glasses of the glasses the user wears. The left-eye video and the right-eye video, which correspond respectively to the polarizations of the left and right eye glasses and which are differently polarized, are output simultaneously to separate the video shown to the left eye and the video shown to the right eye according to the polarization status to generate a parallax difference between the left eye and the right eye.

In this case, the receiver 4 outputs the video signal from the video signal output unit 41 to an external 3D video display device, and the 3D video display device displays the left-eye video and the right-eye video in the different polarization statuses. Alternatively, the video is displayed similarly on the display 47 of the receiver 4.

In this method, the user with polarization glasses can view 3D video on the 3D video display device or on the display 47 of the receiver 4, Note that the polarization display method allows the user to view 3D video without transmitting the synchronization signal and the control signal from the receiver 4, thus eliminating the need for the synchronization signal and the control signal to be output from the control signal output unit 43 and the device control signal transmission terminal 44.

In addition to the methods described above, the anaglyph method, parallax barrier method, lenticular lens method, micro-lens array method, and light ray reproduction method may be used.

The 3D display method of the present invention is not limited to a particular method.

### <Content Recording Processing>

In addition to a conventional 2D broadcast, there is a possibility that a 3D broadcast will be transmitted by the method described above. In that case, there may be a need for converting a 3D broadcast to 2D video image content for recording (2D conversion recording) to reduce the size of data to be recorded. In this embodiment, the following describes a method for appropriately recording 3D broadcast content to a recording medium of the receiver as 2D content.

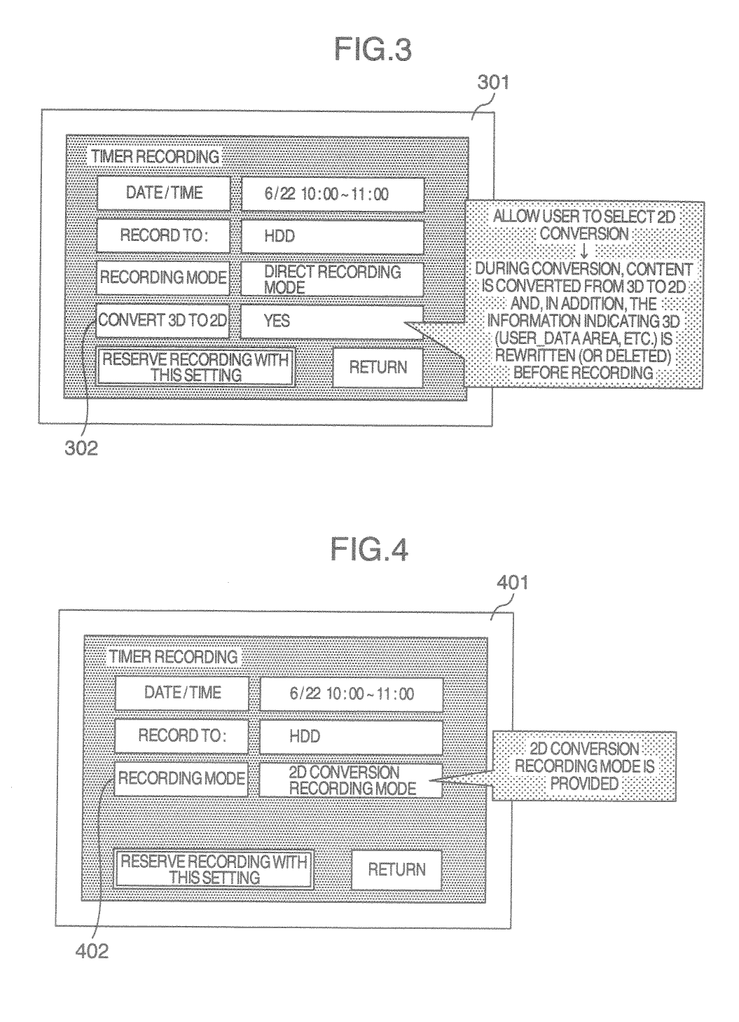

First, the following describes a method for selecting in this embodiment whether to perform 2D conversion recording. For example, as shown in FIG. 3 and FIG. 4, a GUI screen display, such as the timer-recording screen or the dubbing screen of a program, is displayed to allow the user to select whether to perform the conversion processing. This method enables the user to arbitrarily specify the 2D conversion on a content basis. It is possible to employ a method that does not perform the conversion processing if the timer-recording program is not a 3D program.

It is also possible to prepare a similar selection screen on the setting menu screen, to maintain the contents that are set on this screen, and to use the setting automatically at a later recording time or dubbing processing time.

Another possible method is to detect the display performance of the display unit which is included in the reception unit or the display device to which the receiver is connected to allow the receiver to select the 2D conversion recording automatically. For example, when the receiver is the receiver 4 shown in FIG. 13, the information indicating the display performance is acquired from the display 47 via the control bus for example, EDID(Extended Display Identification Data) is acquired via HDMI).

The information is examined to determine whether the display device can display 3D content and if the display device cannot display 3D content or is compatible only with 2D display, the receiver automatically selects the 2D conversion and recording at recording time A configuration is also possible in which the setting of whether to perform the 2D conversion recording automatically is switched between enable and disable on the setting menu screen. Note that the method for selecting whether to perform the 2D conversion recording in this embodiment is not limited to those described above.

As an example, the following describes the operation of the components when 2D conversion recording is performed for 3D content in the SBS format. When the 2D conversion recording is selected, the 2D recording start instruction is transmitted to the system control unit 51. The system control unit 51 that has received the instruction instructs the recording/reproduction control unit 58 to start the 2D conversion recording The recording/reproduction control unit 58 that has received the instruction controls the recording/reproduction unit 27 to perform the 2D conversion recording.

For the 2D conversion recording method of video, FIG. 6 shows a case in which video in the SBS format is converted to 2D for recording. The frame sequence (L1/R1, L2/R2 L3/R3, . . . ) in the left half of FIG. 6 represents the SBS format video signals where the left-eye video signal and right-eye video signal are arranged on the left side and right side, respectively, in one frame.

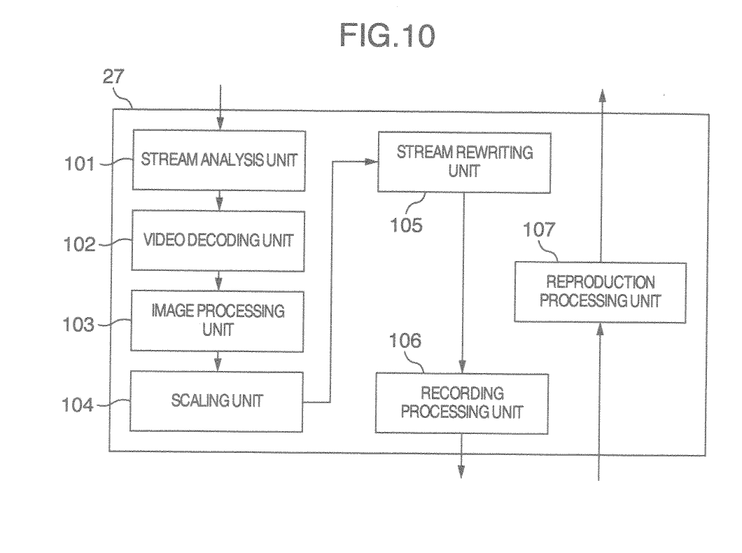

FIG. 10 is a general diagram showing the functional blocks provided in the recording/reproduction unit 27 that performs the 2D conversion recording processing A stream analysis unit 101 analyzes an input stream and acquires the internal data such as the 3D identifier. The stream analysis unit 101 may also acquire the contents of data, such as program information, multiplexed in the stream.

A video decoding unit 102 decodes the video data included in the input stream. This video decoding unit, which is primarily used for performing the image processing and has a role different from that of the video decoding unit of the receiver 4, may be used for video decoding at normal operation time An image processing unit 103 performs image processing for the video data acquired by the video decoding unit 102, for example, vertically divides the video data into the left half and the right half.

A scaling unit 104 performs image processing for the video data acquired by the mage processing unit 103, for example, increases the video data to a predetermined field angle. The image processing unit 103 described above may have the function similar to that of the scaling unit 104.

A stream rewriting unit 105 rewrites data such as the 3D identifier included in a stream, The data that is rewritten in this embodiment will be described later. A recording processing unit 106 accesses a connected recording medium and writes data.

A reproduction processing unit 107 reproduces data from a recording medium. Those functional blocks may be installed as hardware or may be provided as software modules. Although the recording/reproduction unit 27 is controlled by the recording/reproduction control unit 58 that is a functional module in the CPU 21, the functional modules of the recording/reproduction unit 27 may operate automatically or individually.

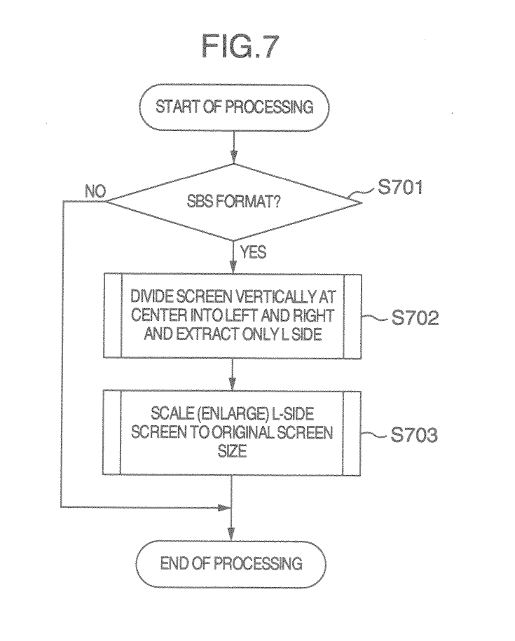

FIG. 7 is a flowchart showing the processing procedure for converting SBS format content to 2D. After starting the processing, a determination is made in S701 whether the video is in the SBS format. This determination is made, for example, by the stream analysis unit 101 that analyzes the stream and checks if there is a 3D identifier indicating the 3D video format.

If the video is not in the SBS format, the processing is terminated in this example. The determination may be continued to check if the video is in a non-SBS format, in which case control is passed to the 2D conversion processing corresponding to the format.

If the video is in the SBS format, control is passed to S702. In this step, the image processing unit 103 vertically divides the video data of each SBS format frame of the video signal, which has been decoded by the video decoding unit 102, into the left half and the right half to produce the left-eye video (L side) and right-eye video (R side) corresponding to the left side and the right side.

After that control is passed to S703 and, in this step, the scaling unit 104 scales only the main view video part (for example, L side), extracts only the main view video (left eye video) as the video signal as indicated by the frame sequence (L1, L2, L3, . . . ) shown in the right half of FIG. 6, outputs the extracted video signal, and terminates the processing. In this way, the converted 2D video stream is produced. The content is recorded on the recording medium 26 as 2D content by the processing described above. The present invention is not limited to the 3D video format and the 2D conversion recording method described above.

In addition, during the 2D conversion recording performed by the method described above, the processing is performed to change the data in the user data area from the data indicating 3D content to the data indicating 2D content.

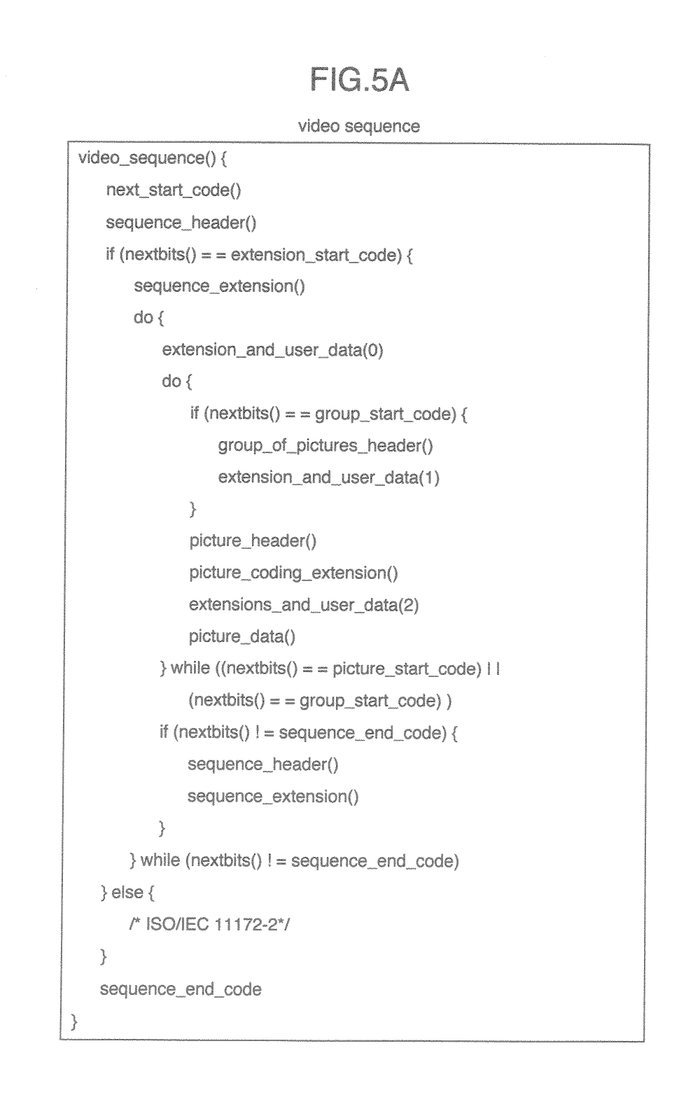

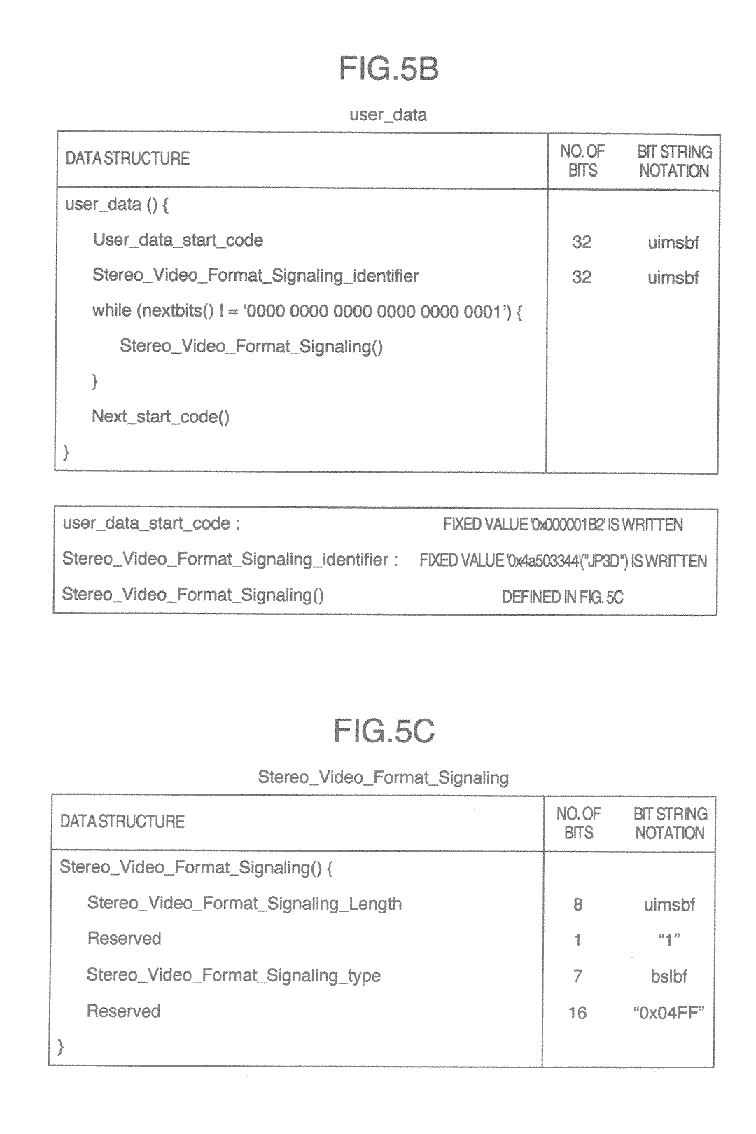

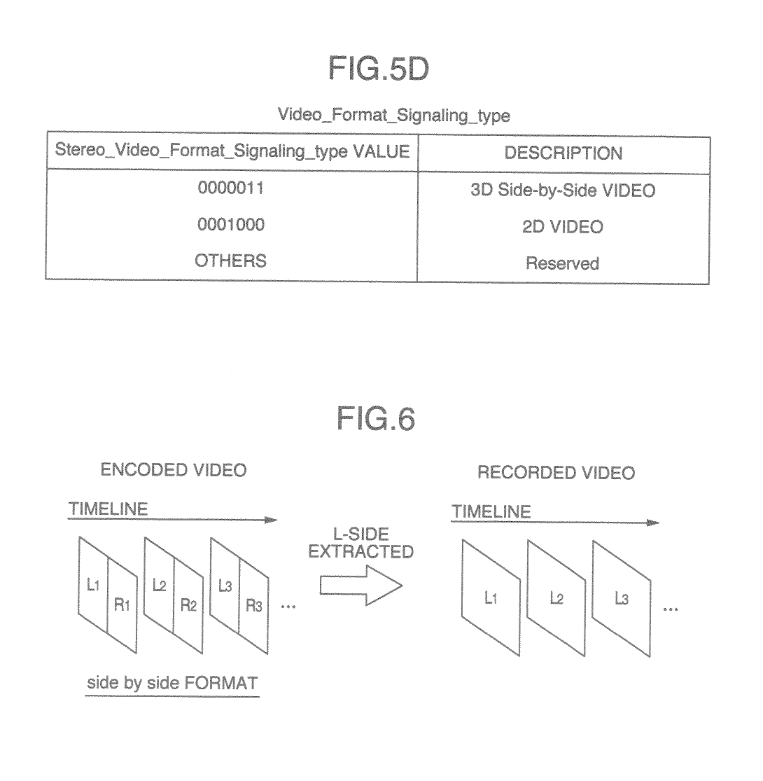

FIGS. 5A-5D show an example of the data structure in which the 3D identifier, which is rewritten in this embodiment, is stored. In this example, the 3D identifier is defined in user_data in the MPEG-2 Video picture layer.

user_data is managed in the picture layer in video_sequence shown in FIG. 5A. In user_data, Stereo_Video_Format_Signaling is defined according to FIG. 5B. In this example, only one Stereo_Video_Format_Signaling ( )is provided in user_data ( ).

Stereo_Video_Format_Signaling_type in Stereo_Video_Format_Signaling shown in FIG. 5C is data that identifies the 3D video format. FIG. 5D shows the type of each format.

In this example, the data is 0000011 for SBS, and 0001000 for 2D. In this embodiment, this Video_Format_Signaling_type corresponds to the 3D identifier. Although only the SBS format is described as the 3D video format for brevity, the definition of the 3D identifier and the stream method that is used are not limited to the SBS format but the TAB format or 3D, 2-view ES transmission method (multi-view stream) may be defined individually.

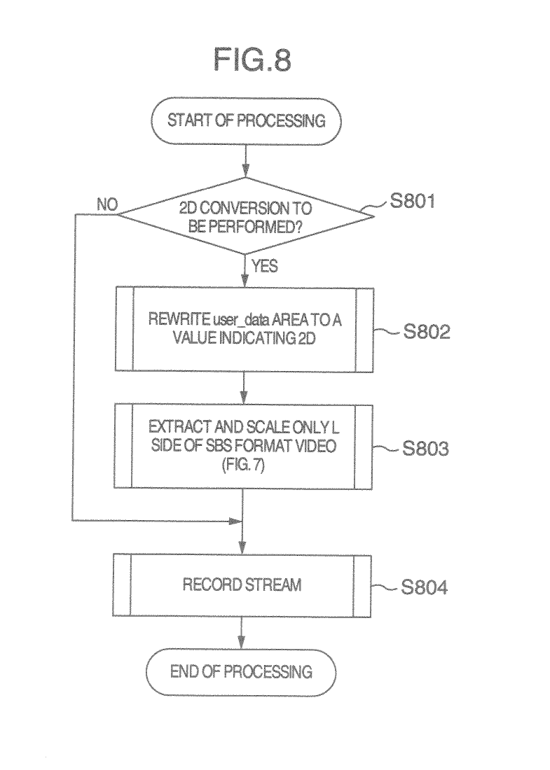

FIG. 8 is a diagram showing an example of the 2D conversion recording processing in this embodiment. After the processing is started, a determination is made in S801 whether the 3D-to-2D content conversion and recording processing is to be performed. This determination is made by the methods described above; that is, the display performance of the receiver or the display performance of the connected display device is detected to automatically select whether to perform 2D conversion processing or the GUI screen such as that shown in FIGS. 3 and 4 is displayed to allow the user to select whether to perform 2D conversion recording. Any other method may also be used.

If the 2D conversion is not performed, control is passed to S804, the stream is recorded as 3D content, and the processing is terminated. If the 2D conversion is performed, control is passed to S802 and the stream rewriting unit 105 rewrites the 3D identifier of the stream from the value indicating the SBS format to the value indicating 2D video.

In the data structure described above, the stream rewriting unit 105 rewrites the value of Stereo_Video_Format_Signaling_type shown in FIG. 5D, which is in user_data in the picture layer in the stream, from 0000011 to 0001000.

After that, control is passed to S803 to convert the SBS stream to 2D according to the 2D conversion method described above. In S803, only the L-side video of the SBS format video is extracted and scaled, as in the example shown in FIG. 7, to produce 2D video.

After the 3D identifier is rewritten and the 2D video format stream is extracted as described above, control is passed to S804, the stream is recorded on the recording medium, and the processing is terminated. When recording the stream in S804, the compression format change processing through the transcode function, the compressed recording (translate) processing by decreasing the bit rate of the recording data, and the high definition processing through the super-resolution technique may be performed.

The similar effect may be achieved also when the order of S802 and S803 is reversed When content is converted from 3D video to 2D video, the 3D identifier may be deleted (for example, because the data structure described above is compatible with the conventional 2D broadcast method even when the 3D identifier is not provided, the receiver can identify that the content is 2D video even when the 3D identifier is deleted).

Although user_data in the picture layer in video_sequence defined by MPEG2 video is managed in the example above, the present invention is not limited to this information. For example, the program information (SI, component descriptor, etc.) may be used and, in that case, the 3D identifier defined in that data may be rewritten or deleted. In this case, the stream analysis unit 101, one of the functions of the recording/reproduction unit 27, analyzes the program information acquired from the de-multiplexing unit 29, and the stream rewriting unit 105 rewrites or deletes the data indicating the 3D identifier from the program information. When the data is deleted, the 3D identifier itself may be deleted.

The 3D identifier included in the program information such as SI and the 3D identifier included in user_data in the picture layer in video_sequence defined by MPEG2 video may be managed at the same time. One possible method used in that case is that SI includes the information indicating only whether or not the 3D video is included and that user_data includes the information indicating which 3D method the 3D video uses. In exemplary processing in which such management is performed, SI having information indicating whether or not 3D video is included is deleted and, in addition, the information contents included in user_data to indicate the 3D method is rewritten or deleted when the 2D conversion recording processing is performed. When the information contents are deleted, the 3D identifier itself may be deleted. For the rewriting processing or the deletion processing, the methods described above or any other method may be used.

In this embodiment, 3D video content may be recorded as 2D video content to reduce the data size and, in addition, the recorded 2D content may be processed appropriately.

More specifically, when content is output on a display device capable of changing the display method according to the 3D identifier, the content can be displayed appropriately. In addition, when converted content is managed on a recording device, the content can be determined correctly as 2D content.

Consider the case in which, if the recording medium 26 is a removable device or example, iVDR), this recording medium 26 is removed and connected to another recording/reproduction device (or receiver or display device) for reproduction. In this case, even if the another recording/reproduction device can process only 2D video content, the method in this embodiment converts the content to 2D video content and prevents a mismatch in the 3D identifier, thus potentially increasing compatibility with other devices.

Next, the following describes an example in which a 2D broadcast in the conventional broadcast method is converted to, and recorded as, 3D video to produce high reality-effect content.

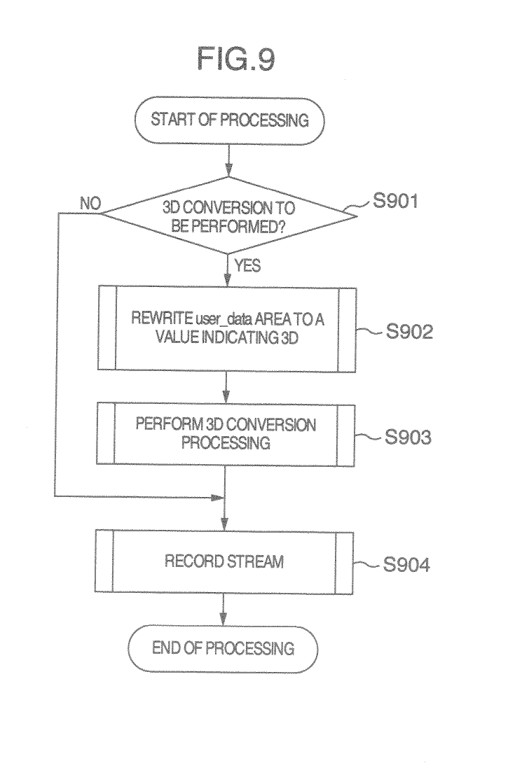

FIG. 9 is a diagram showing an example of 3D conversion recording processing in this embodiment. Although the data structure used in this embodiment to indicate the data structure of the 3D identifier is as shown in FIGS. 5A-5D and the converted 3D video format is an arbitrary format, the present invention is not limited to this structure and format.

After the processing is started, a determination is made in S901 whether content is to be converted from 2D to 3D. If the 3D conversion is not performed, control is passed to S904 the stream is recorded as 2D content, and the processing is terminated.

If the 3D conversion is performed, control is passed to S902 and the recording/reproduction unit 27 rewrites the 3D identifier of the stream from the value indicating 2D video to the value indicating 3D video. This value is the value used in the conversion processing in S903 that will be performed later.

For example, to convert 2D content to SBS format 3D content, the recording/reproduction unit 27 rewrites the value of Stereo_Video_Format_Signaling_type shown in FIG. 5D, which is in user_data in the picture layer in the stream, from 0001000 to 0000011. After that, control is passed to S903 to convert the content to 3D. The 3D conversion processing will be described later.

After the 3D identifier is rewritten and the 3D video format stream is generated as described above, control is passed to S904, the stream is recorded on the recording medium, and the processing is terminated.

When recording the stream in S904, the compression format change processing through the transcode function, the compressed recording (translate) processing by decreasing the bit rate of the recording data, and the high definition processing through the super-resolution technique may be performed. The similar effect may be achieved also when the order of S902 and S903 is reversed.

The 3D conversion processing is performed, for example, by analyzing an image to estimate the depth of the image and based on the estimated depth, adding a parallax difference to the image. The image to which the parallax difference is added is converted to the SBS format to produce 3D video. Note that the 3D conversion processing in this embodiment is not limited to this method.

Although user_data in the picture layer in video_sequence defined by MPEG2 video is managed in the example above, the present invention is not limited to this information. For example, the program information (SI, component descriptor, etc) may be used and, in that case, the 3D identifier defined in that data is added or rewritten. In this case, the stream rewriting unit 105, one of the functions of the recording/reproduction unit 27, adds data, which indicates the 3D identifier, to SI or rewrites it according to the executed 3D conversion method.

The 3D identifier included in the program information such as SI and the 3D identifier included in user_data in the picture layer in video_sequence defined by MPEG2 video may be managed at the same time. For example, when the 3D conversion and recording is performed, the processing may be performed to add the information indicating that the 3D image is included to SI and, in addition, to add or rewrite the information and identifier indicating the 3D method in user_data. For the addition or rewriting processing, the methods described above or any other method may be used.

In this embodiment, 2D video content in the conventional broadcast method may be recorded as a more realistic 3D video content and, in addition, the recorded 3D content may be processed appropriately. More specifically, content may be displayed appropriately on a display device capable of changing the display method according to the 3D identifier and, when converted content is managed on a recording device, the content can be determined correctly as 3D content.

Next, the following describes the processing that is performed when 3D content, which is to be recorded as 3D content, does not have an identifier indicating 3D content (or has an identifier having the value indicating 2D content).

Because the specification does not require the insertion of a 3D identifier, because the broadcast is in the process of transition to the 3D content broadcast, or because there is a problem with the broadcast facility of the broadcasting station, 3D content that does not have a 3D content identifier or has a 3D identifier that has a value indicating 2D content may be broadcast.

If such content is recorded directly on the receiver, even the receiver capable of displaying content in 3D cannot identify the content by the 3D identifier. This sometimes results in a possibility that the content, which is determined to be 2D content at content reproduction time, cannot be displayed in 3D. Such processing requires the user, who reproduces the content, switch to the 3D display each time the user wants to display the content in 3D, with a potential decrease in ease of use.

To address this problem, this embodiment allows the receiver to add a 3D identifier before recording if the content to be recorded is 3D content and if the content does not have a 3D identifier (or has an identifier that have a value indicating 2D content).

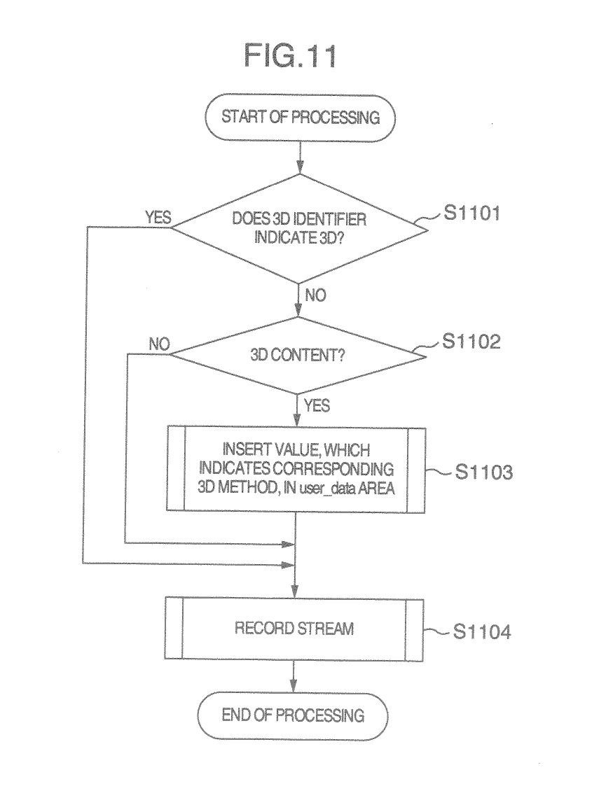

FIG. 11 is a diagram showing an example of the processing procedure used in this embodiment. Although the data structure indicating a 3D identifier described in this embodiment is the ore shown in FIGS. 5A-5D, the present invention is not limited to this structure.

After starting the processing, the value of the 3D identifier is checked in S1101. This processing is performed, for example, by analyzing the stream by the stream analysis unit 101 in the recording/reproduction unit 27 to check if the 3D identifier has a value indicating 3D content.

If the 3D identifier has a value indicating 3D content as the result of checking in S1101, control is passed to S1104 and the stream is recorded directly as 3D content. If the 3D identifier has a value not indicating 3D content, control is passed to S1102 to determine if the stream is in the 3D content format. This determination algorithm will be described later.

If the content is determined as 2D content as the result of determination in S1102, control is passed to S1104 to record the stream directly as 2D content. If the content is determined as 3D content, control is passed to S1103 to insert the 3D identifier.

To insert the 3D identifier, the recording/reproduction unit 27 detects the position in the stream at which the 3D identifier is to be inserted and inserts data, which has the value indicating 3D video, in that position (rewrite data). The value of this 3D identifier is set according to the result of the 3D content format that has been determined. For example, if the content is determined as an SBS format 3D content, the data having the value of 0000011 is inserted into user_data in the picture layer in the stream as the value of Stereo_Video_Format_Signaling_type shown in FIG. 5D.

After the 3D identifier is rewritten in S1103, control is passed to S1104, the stream is recorded, and the processing is terminated. When recording the stream in S1104, the compression toting change processing through the transcode function, the compressed recording (translate) processing by decreasing the bit rate of the recording data, and the high definition processing through the super-resolution technique may be performed.

Because whether or not content to be recorded is 3D cannot be determined by the 3D content identifier in this embodiment (this is because the content is 3D content that has not a 3D identifier), several methods are used to determine whether or not the content is 3D content. In one method, the user performs the operation at recording time to notify the receiver that the content is 3D content. In another method, based on the fact that the left-eye content and the right-eye content are arranged on the left side and the right side in SBS-format 3D content, the receiver automatically determines whether or not the content is 3D content by means of an algorithm in which the image processing unit divides the image at a given time into two at the center, creates the brightness histograms of the left-side and the right-side for comparison and, if the left-side image and right-side image are found to be similar as the result of the comparison, determines that the content is SBS-format 3D content. The 3D determination method in this embodiment is not limited to the methods described above. This determination may be made by the CPU 21 or a determination unit may be provided separately to make this determination.

Although user_data in the picture layer in video_sequence defined by MPEG2 video is used in the example above, the present invention is not limited to this information. For example, the program information (SI, component descriptor, etc.) may be used and, in that case, the 3D identifier defined in that data is added or rewritten. In this case, the stream rewriting unit 105, one of the functions of the recording/reproduction unit 27, adds data, which indicates the 3D identifier, to SI or rewrites it according to the content 3D format.

The 3D identifier included in the program information, for example SI, and the 3D identifier included in user_data in the picture layer in video_sequence defined by MPEG2 video may be managed at the same time. For example, the processing may be performed to add the information indicating that the 3D image is included to SI and in addition, to add or rewrite the information and identifier indicating the 3D method in user_data. For the addition or rewriting processing, the methods described above or any other method may be used.

Even if a stream includes 3D content that does not have a 3D identifier, this embodiment records the content with the 3D identifier added to allow the receiver to process the recorded content as 3D content, increasing the ease of use at viewing time.

The setting menu screen or the timer-recording screen may be configured to allow the user to select whether or not a 3D identifier is to be added to a stream that includes 3D content but does not have a 3D identifier.

Next, when a broadcast failure or error occurs, there is a possibility that content, which is 2D content but to which a 3D identifier indicating that the content is 3D content is added, is broadcast. If such content is recorded directly on the receiver, the 3D-capable receiver, which identifies the content type based on the 3D identifier, misidentifies the content as 3D content though the content is actually 2D content. As a result, the content may not be displayed correctly because the content is displayed in the 3D display method Such a receiver requires the user to switch to the 2D display each time the user reproduces the content, decreasing the ease of use.

To address this problem, if content to be recorded is 2D but a 3D identifier is added to it, the receiver deletes the 3D content identifier and records the content in this embodiment.

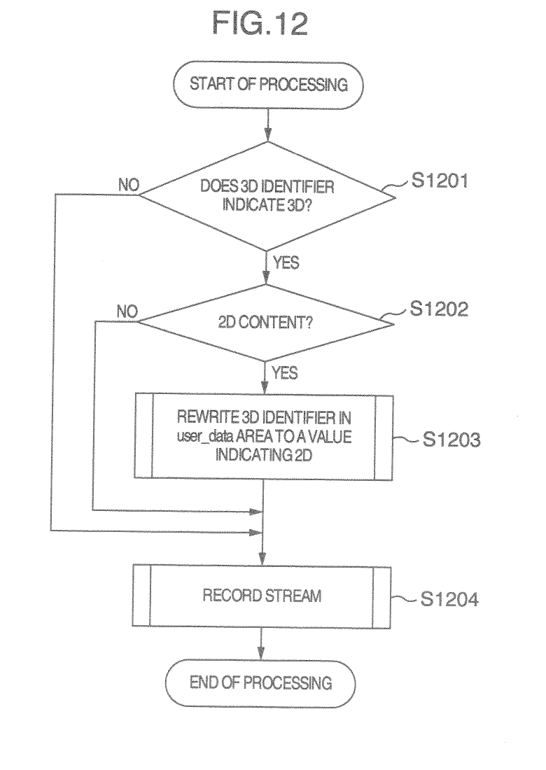

FIG. 12 is a diagram showing an example of the processing procedure used in this embodiment. Although the data structure indicating a 3D identifier described in this embodiment is the one shown in FIGS. 5A-5D, the present invention is not limited to this structure.

After the processing is started, the value of the 3D identifier is determined in S1201. To perform this processing, the stream analysis unit 101 in the recording/reproduction unit 27 analyzes the stream to check if the 3D identifier has the value indicating 3D content. If the 3D identifier has the value indicating 2D content as the result of the determination in S1201, control is passed to S1204 to directly record the stream as 2D content.

If the 3D identifier has the value indicating 3D content, control is passed to S1202 to check if the stream is 2D content. For this determination algorithm, the 3D content determination method described above or any other method may be used.

If the stream is determined as 3D content as the result of determination in S1202, control is passed to S1204 to record the stream directly as 3D content. If the content is determined as 2D content, control is passed to S1203 to rewrite the value of the 3D identifier indicating 3D content (or deletes 3D identifier).

To rewrite the value of the 3D identifier, the recording/reproduction unit 27 detects the 3D identifier in the stream and rewrites the value to the value indicating 2D video. More specifically, the recording/reproduction unit 27 rewrites the value of Stereo_Video_Format_Signaling_type shown in FIG. 5D, which is in user_data in the picture layer in the stream, to 0001000. After the 3D identifier is rewritten in S1203, control is passed to S1204 to record the stream and then the processing is terminated.

At this time, the compression format change processing through the transcode function, the compressed recording (translate) processing by decreasing the bit rate of the recording data, and the high definition processing through the super-resolution technique may be performed.

Although user_data in the picture layer in video_sequence defined by MPEG2 video is used in the example above, the present invention is not limited to this information. For example, the program information (SI, component descriptor, etc.) may be used and, in that case, the 3D identifier defined in that data is rewritten or deleted. In this case, the stream analysis unit 101, one of the functions of the recording/reproduction unit 27, analyzes the program information obtained from the de-multiplexing unit 29 and the stream rewriting unit 105 rewrites or deletes the data indicating the 3D identifier based on the program information. When deleting the data, the 3D identifier itself may be deleted.

If both the 3D identifier included in the program information, for example SI, and the 3D identifier included in user_data in the picture layer in video_sequence defined by MPEG2 video are included, SI that has information indicating whether 3D video is included is deleted and, in addition, information contents indicating the 3D method included in user_data is rewritten or deleted. When deleting the information, the 3D identifier itself may be deleted. As the method of the rewriting processing or deletion processing, the methods described above or any other method may be used.

Even if a stream includes 2D content that has a 3D identifier due to an error, this embodiment deletes (rewrites) the 3D identifier and records the stream to allow the receiver to process the recorded stream correctly as 2D content, increasing the ease of use at viewing time.

The setting menu screen or the timer-recording screen may be configured to allow the user to select whether or not the 3D identifier in the stream, in which a 3D identifier is added to 2D content, is to be deleted (rewritten).

It should be further understood by those skilled in the art that although the foregoing description has been made on embodiments of the invention, the invention is not limited thereto and various changes and modifications may be made without departing from the spirit of the invention and the scope of the appended claims.

1. A receiver that receives a digital broadcast signal, comprising:
a reception unit that receives a digital broadcast signal that includes content, the content including a video signal and identification information indicating that the video signal includes a 3D video signal;
a conversion unit that converts a 3D video signal to a 2D video signal;
a control unit that controls the identification information; and
a recording unit that can record the content to a recording medium, the content included in the digital broadcast signal received by said reception unit wherein
said conversion unit converts a 3D video signal, included in the content, to a 2D video signal and, when the content is recorded to the recording medium, said control unit rewrites or deletes the identification information included in the content.

2. The receiver according to claim 1 wherein
the identification information further comprises information indicating a 3D method type of the video signal included in the content, and
said conversion unit converts the video signal to the 2D video signal according to the 3D method indicated by the identification information.

3. A receiver that receives a digital broadcast signal, comprising:
a reception unit that receives a digital broadcast signal that includes a video signal,
a conversion unit that converts a 2D video signal to a 3D video signal;
a control unit that controls identification information indicating that the video signal includes a 3D video signal; and
a recording unit that can record content on a recording medium, the content included in the digital broadcast signal received by said reception unit wherein
said conversion unit converts a 2D video signal, included in the content, to a 3D video signal and, when the content is recorded to the recording medium, said control unit appends the identification information to the content.

4. The receiver according to claim 3 wherein
the identification information further comprises information indicating a 3D method type of the video signal included in the content, and
said appended identification information indicates a 3D method of the 3D video signal converted by said conversion unit.

5. A receiver that receives a digital broadcast signal, comprising:
a reception unit that can receive a digital broadcast signal that includes content, the content including a video signal and identification information indicating that the video signal includes a 3D video signal;
a control unit that controls the identification information; and
a recording unit that can record the content to a recording medium, the content included in the digital broadcast signal received by said reception unit wherein
if the video signal of the content included in the digital broadcast signal received by said reception unit is a 3D video signal, said control unit rewrites or appends the identification information if the identification information on the content does not indicate that a 3D video signal is included or if the identification information on the content is not included in the content.
